(19) United States
(12) Patent Application Publication
(10) Pub. No.: US 2005/0055466 A1
(43) Pub. Date: Mar. 10, 2005

(54) Automatic network provisioning system

(75) Inventors: Michitaka Matsuno, Tokyo (JP); Shoichiro Nakai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/936,537

(22) Filed: Sep. 9, 2004

(30) Foreign Application Priority Data
Sep. 10, 2003 (JP) 318042/2003

(51) Int. Cl. G06F 15/16; G06F 12/00

(52) U.S. Cl. 709/249

(57) ABSTRACT

An equipment and an automatic network provisioning section. The equipment is configured to connect a terminal on a first network with a second network through a communication circuit based on a current parameter data. The automatic network provisioning section is connected with the equipment and acquires an equipment data containing an actual parameter data from the equipment in response to an acquisition instruction and dynamically sets a new parameter data to the equipment based on the actual parameter data.

### BACKGROUND OF THE INVENTION

1. Field of the Invention

The present invention relates to an automatic network provisioning server and a system using the same.

2. Description of the Related Art

As spreading of a broadband network in recent years, it is often necessary to change a network operation (operation of a communication circuit to connect a terminal on a data network with a computer network such as the Internet) in accordance with a request from an end user or a system environment of the end user. For example, in an ADSL service, because the circuit length of a telephone circuit, noise generation factors and so on is different every end user, an optimal network operation is different every end user. Also, in the ADSL service, the ADSL circuit becomes instable under a bad condition, and sometimes falls into a situation in which communication cannot be carried out at all. Therefore, it is necessary to change the circuit configuration according to the operation situation of every circuit.

Generally, in order to respond to a request from the end user, an operator receives the request from the end user in a call center, and carries out a setting to a network equipment as a request object through a network management system (NMS) in accordance with the request from the end user. However, such an operation system of a network needs many operators having advanced technique and knowledge and is not efficient. Therefore, the development of a system by which a work of the operator can be replaced is demanded.

For the replacement of the work of the operator, an automatic network provisioning system is disclosed in Japanese Laid Open Patent Application (JP-A-Heisei 10-98480) as a first conventional example, and a network control system is disclosed in Japanese Laid Open Patent Application (JP-P2000-244495A) as a second conventional example.

Also, a cooperative scheduling type Qos control system is disclosed in Japanese Laid Open Patent Application (JP-P2003-69631A) as a third conventional example. In the control system of the third conventional example, a network control unit generates a schedule when service is provided from a service server to a client based on a use request condition acquired from the client and a service property acquired from the service server. Thus, it is aimed to improve the use efficiency of a network bandwidth by controlling network use between nodes in a time divisional manner in accordance with the service property.

However, in the above conventional examples, the following problems exist:

(1) Predetermined values are set to each node and it is not possible to carry out automatic setting based on a dynamic operation situation of each circuit in the node. That is, the setting of each circuit is changed based on the physical configuration of a system.

(2) Because the configuration of each node is determined based on a physical position and a logical identifier such as an IP address of the node, a combination of parameters becomes complex when the number of the nodes increases. Therefore, the network operation cannot be provided in accordance with the request from the end user and the system environment of the end user.

Especially, in the third conventional example, data acquired from the client by the network control unit is a use condition of the network when a service is provided from the service server. It is not data of the status of a circuit allocated to each client. Therefore, the setting can be carried out in accordance with the request of the end user but the network cannot be dynamically set in accordance with the actual circuit status of each client.

In this way, in case of the communication circuits like ADSL, in which the optimal operation condition is different for every circuit, it is not conventionally possible to dynamically carry out the setting change of the communication circuit of an equipment which connects a terminal on an information network with a computer network through a communication circuit, to an optimal setting for every circuit in accordance with the request from the end user and the environment of the end user.

In conjunction with the above description, a network system is disclosed in Japanese Laid Open Patent Application (JP-A-Heisei 8-110878). In the network system of this conventional example has a server node and nodes controlled by the server node. The node contains a physical configuration data acquiring section which acquires a physical configuration data of the node, an identifier storing section which stores an identifier allocated to the node, and a node data transmitting section which transmits the identifier and the physical configuration data to the server node. The server node contains a node data receiving section which receives the identifier and the physical configuration data of the node transmitted by the node data transmitting section, and a parameter generating section which generates a parameter for the network setting based on the received physical configuration data.

Also, a network control system is disclosed in Japanese Laid Open Patent Application (JP-A-Heisei 11-346224). In this conventional example, when the configuration data of a plurality of logical networks with different protocols to be used, and setting data of the plurality of equipments on a network are referred and changed, user data on the network and the data of an organization to which the user belongs are displayed, and a changing process and an updating process are carried out in connection with the referring operation or the changing operation of the user data or the organization data.

Also, a method of setting a security policy in a virtual communication network is disclosed in Japanese Laid Open Patent Application (JP-P2000-324104A). In this conventional example, a plurality of communication terminals for a virtual network are selected on a network mapping screen to specify a setting range. A communication condition for the specified setting range is selected from a security policy data table in which communication conditions containing cipher algorithm are previously written. Thus, a communication path on the network is searched based on the specified setting range and the selected communication condition, and network equipments of the searched communication path are searched. Then, the selected communication condition is sequentially set to the searched network equipments.

Also, a data relay apparatus is disclosed in Japanese Laid Open Patent Application (JP-P2001-230805A). In this conventional example, the data relay apparatus is composed of an apparatus control section which manages the whole apparatus and sets a transferring method of packets, a packet transmitting and receiving section which is connected with a communication network to transmit and receive a data packet to and from the communication network, and a packet switching section. A static data collecting section collects static data of the packets transmitted or received by the packet transmitting and receiving section. A static data management section manages the static data and generates a notice event when a specific change is caused in the static data. A notifying section is called from the static data collecting section to notify one or both of the static data and notice even to a static data using section which is previously registered. The static data using section changes an operation based on a previously set condition when the notice is received from the notifying section.

### SUMMARY OF THE INVENTION

An object of the present invention is to provide an automatic network provisioning server and a system for the same, in which it is possible to dynamically carry out the change of the setting of a communication circuit of an equipment which connects a terminal on a data network with a computer network such as the Internet through the communication circuit to an optimal setting for every circuit in accordance with a request from an end user and a system environment of the end user.

In an automatic network provisioning system includes an equipment and an automatic network provisioning section. The equipment is configured to connect a terminal on a first network with a second network through a communication circuit based on a current parameter data. The automatic network provisioning section is connected with the equipment and acquires an equipment data containing an actual parameter data from the equipment in response to an acquisition instruction and dynamically sets a new parameter data to the equipment based on the actual parameter data.

Here, the automatic network provisioning section may include an automatic network provisioning server which is connected with the equipment through a management network and acquires the equipment data containing the actual parameter data in response to the acquisition instruction and dynamically sets the new parameter data to the equipment based on the acquired actual parameter data.

Instead, the automatic network provisioning section may include an equipment control server and an automatic network provisioning server. The equipment control server is connected with the equipment and acquires the equipment data containing the actual parameter data in response to the acquisition instruction, transfers the equipment data in response to a transfer instruction, and sets the new parameter data to the equipment when the new parameter data is received. The automatic network provisioning server is connected with the equipment through a management network, and issues the transfer instruction to the equipment control server, determines the new parameter data based on the actual parameter data and transfers the new parameter data to the equipment control server. In this case, the automatic network provisioning system may further include a plurality of the equipment control servers and a plurality of the equipments. The plurality of equipment control servers are provided for the automatic network provisioning server provided in an area where the automatic network provisioning server is provided. The plurality of the equipments are provided for each of the equipment control servers. Also, the automatic network provisioning system may further include a plurality of the equipment control servers and a plurality of the equipments. The plurality of equipment control servers are provided for the automatic network provisioning server in a first area, and the automatic network provisioning server is provided in a second area different from the first area. The plurality of equipments provided for each of the equipment control servers.

The automatic network provisioning server may include a collection section which acquires the equipment data containing the actual parameter data from the equipment in response to the acquisition instruction, and determines a status of the communication circuit based on the actual parameter data; and an equipment setting section which determines the new parameter data based on the determination result and sets the new parameter data to the equipment. In this case, the automatic network provisioning server may further include a storage section which stores a conversion table. The collection section stores the equipment data in the storage section, reads out the equipment data from the storage section, and determines the determination result based on the actual parameter data of the equipment data. The equipment setting section determines the new parameter data based on the determination result and the conversion table sets the new parameter data to the equipment. Also, the automatic network provisioning server may further include a timer section which generates a trigger at a predetermined time. The collection section generates the acquisition instruction in response to the trigger. Also, the automatic network provisioning system may further include a client section generates the acquisition instruction.

Also, the equipment control server may include a control section which acquires the equipment data containing the actual parameter data from the equipment in response to the acquisition instruction, transfers the equipment data to the automatic network provisioning server in response to the transfer instruction, and sets the new parameter data to the equipment when the new parameter data is received. In this case, the equipment control server may further include a first timer section which generates a first trigger at a predetermined time. The control section generates the acquisition instruction in response to the first trigger. Also, the automatic network provisioning sever may include a collection section which transmits the transfer instruction to the equipment control server and determines a status of the communication circuit based on the actual parameter data; and an equipment setting section which determines the new parameter data based on the determination result and transmits the new parameter data to the equipment control server. In this case, the automatic network provisioning sever may further include a storage section which stores a conversion table. The collection section stores the equipment data in the storage section, reads out the equipment data from the storage section, and determines a status of the communication circuit based on the actual parameter data of the equipment data. The equipment setting section determines the new parameter data based on the actual parameter data of the determination result and the conversion table and transmits the new parameter data to the equipment control server. Also, the automatic network provisioning server may further include a second timer section which generates a second trigger at a predetermined time. The collection section generates the transfer instruction in response to the second trigger. Also, the automatic network provisioning system may further include a client section generates the acquisition instruction.

Also, the communication circuit is an ADSL circuit.

In another aspect, the present invention provides an automatic network provisioning sever used in the above-mentioned automatic network provisioning system. Also, the present invention provides an equipment control sever used in the above-mentioned automatic network provisioning system.

In another aspect of the present invention, a method of dynamically changing a setting of an equipment to connect a terminal on a first network with a second network through a communication circuit based on a current parameter data, is achieved by acquiring an equipment data containing an actual parameter data from the equipment in response to an acquisition instruction; and by dynamically setting a new parameter data generated based on the actual parameter data to the equipment.

Here, the acquiring and the dynamically setting may be carried out in a single server. Instead, the acquiring and the dynamically setting may be carried out in a first server. In this case, the method may be achieved by further including generating a transfer instruction in a second server; transferring the equipment data from the first server to the second server in response to the transfer instruction; determining the new parameter data based on the actual parameter data in the second server; and transferring the new parameter data to the first server.

The method may be achieved by further including generating a trigger at a predetermined time in the server; and generating the acquisition instruction in response to the trigger.

Also, the method may be achieved by further including generating a first trigger at a predetermined time; and generating the acquisition instruction in response to the first trigger.

Also, the method may be achieved by further including generating a second trigger at a predetermined time; and
generating the transfer instruction in response to the second trigger.

Also, the method may achieved by further including by generating the acquisition instruction externally.

In another aspect of the present invention, a software product is provided to realize at least one of the above methods.

### BRIEF DESCRIPTION OF THE DRAWINGS

FIG. 1 is a diagram showing the configuration of an automatic network provisioning system according to a first embodiment of the present invention;

FIG. 2 is a diagram showing an example of a data network;

FIG. 3 is a diagram showing a data configuration example of equipment data;

FIG. 4 is a diagram showing a data configuration example of circuit status determination data;

FIG. 5 is a diagram showing a data configuration example of profile data;

FIG. 6 is a diagram showing a data configuration example of profile transition data;

FIG. 7 is a flow chart showing an operation of the automatic network provisioning system in the first embodiment;

FIGS. 8A to 8C are diagrams showing the change of the equipment data in the ordinary operation of the automatic network provisioning server;

FIGS. 9A to 9C are diagrams showing a method of the generation of circuit setting data in the ordinary operation of the automatic network provisioning server 11;

FIG. 10 is a diagram showing the configuration of the automatic network provisioning system according to a second embodiment of the present invention;

FIG. 11 is a diagram showing the configuration of the automatic network provisioning system according to a third embodiment of the present invention;

FIG. 12 is a diagram showing a state in which the automatic network provisioning system according to the third embodiment is built up in a distributed system; and

FIG. 13 is a diagram showing a state in which the automatic network provisioning system according to the third embodiment is built up in a center system.

### DESCRIPTION OF THE PREFERRED EMBODIMENTS

Hereinafter, an automatic network provisioning system of the present invention will be described.

[First Embodiment]

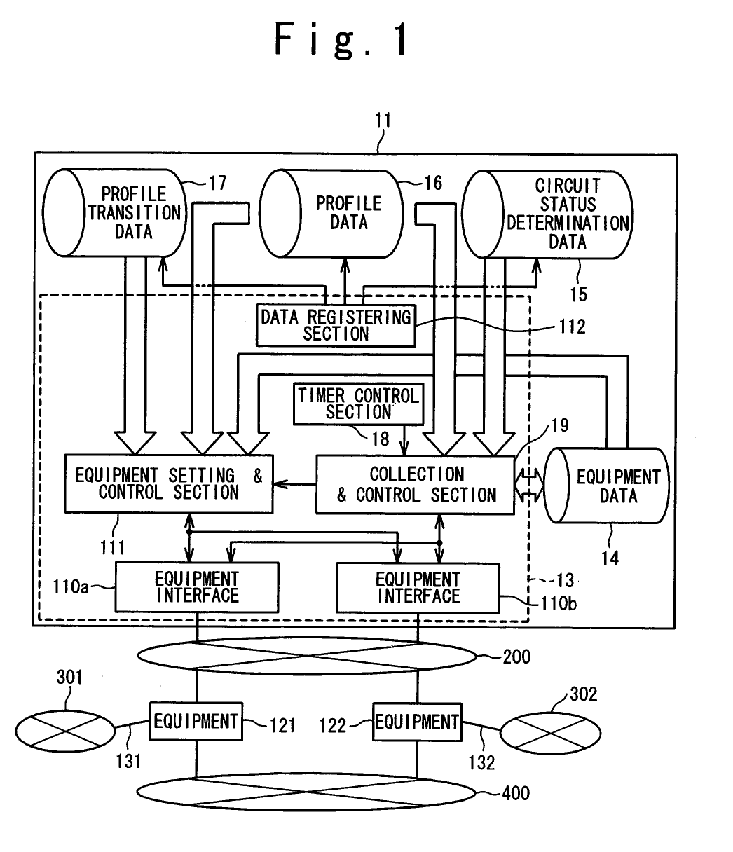

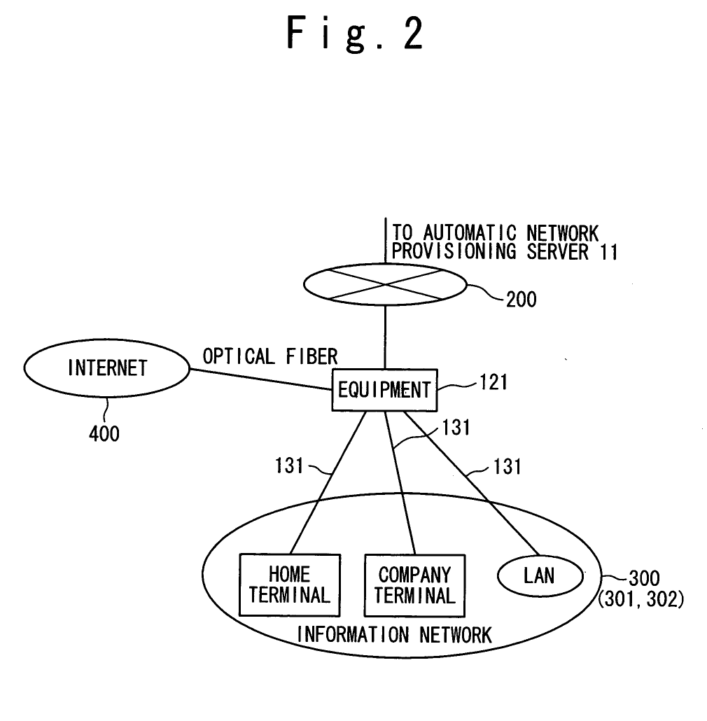

FIG. 1 is a block diagram showing the configuration of the automatic network provisioning system according to the first embodiment of the present invention. Referring to FIG. 1, the automatic network provisioning system contains an automatic network provisioning server 11, and equipments 121 and 122 which are connected with the server 11 through a management network 200. The equipments 121 and 122 are different types of equipments. In other words, logical data of the equipments 121 and 122 for the automatic setting are not same. The equipments 121 and 122 connect data networks 301 and 302 to a computer network 400 such as the Internet through communication circuits 131 and 132, respectively. It should be noted that the management network 200 is a network to carry out transmission and reception of data between servers by an SNMP. For example, the management network 200 is a network such as Ethernet(R) and an ATM network. On the other hand, the data networks 301 and 302 are networks for the end user to use to transmit and receive data. Specifically, the data network is a network containing terminals of the end users or an in-house LAN, as shown in FIG. 2. Also, the communication circuits 131 and 132 are circuits such as ADSL circuits in which the optimal operation conditions are different from each other. The equipments 121 and 122 and the computer network 400 have data transmission rates higher than the communication circuits 131 and 132. For example, the computer network is constituted as an optical fiber network if the communication circuits 131 and 132 are ADSL circuits.

The automatic network provisioning server 11 collects equipment data 14 from the equipments 121 and 122, and dynamically carries out the automatic setting of the communication circuits 131 and 132 allocated to the equipments 121 and 122 based on the equipment data 14. The equipments 121 and 122 are objects of status change by the automatic network provisioning server 11, and provide parameter setting data of the communication circuits 131 and 132 and parameter status data to the automatic network provisioning server 11. The maximum transmission rate of the communication circuit is an example of the parameter setting data, and an actual transmission rates is example of the parameter status data. Data such as a circuit band, a noise margin, ADSL standard, and a bit map are contained in the parameter setting data and the parameter status data, in addition to the transmission rate.

The automatic network provisioning server 11 contains a system program section 13, and a storage section for the equipment data 14, circuit status determination data 15, profile data 16, and profile transition data 17.

The system program section 13 is realized based on a software program and controls the operation of the whole of server 11. The equipment data 14 contains the parameter setting data and the parameter status data and is periodically collected from each of the equipments 121 and 122 through the management network 200. The circuit status determination data 15 is used to carry out the status determination of each of the communication circuit 131 and 132 allocated to the equipment 121 and 122. The profile data 16 is used to define a parameter value group (profile) of the parameter setting data of each of the communication circuit 131 and 132 allocated to the equipment 121 or 122. The profile transition data 17 is used to define the profile of the parameter setting data to be set next based on the circuit status determination result of the communication circuit.

The system program section 13 has a timer control section 18, a collection and control section 19, an equipment setting and control section 111, a data registering section 112, and equipment interfaces 110a and 10b.

The timer control section 18 generates an operation trigger of the system. The collection and control section 19 receives a notice (the operation trigger) from the timer control section 18 and generates an acquisition instruction. Thus, equipment data (parameter setting data and parameter status data) is collected from each of the equipments 121 and 122 through the equipment interfaces 110a or 110b. The collection may be carried out independently between the equipments 121 and 122, and may be carried out at the same time in response to the notice.

The parameter value group of the parameter setting data is converted into a corresponding profile name using the profile data 16. Also, the collection and control section 19 uses the circuit status determination data 15 to carry out a circuit status determination to the collected equipment data 14, and writes the determination result in the equipment data 14. The equipment setting and control section 111 receives a notice from the collection and control section 19 and calculates a profile of parameter values of parameter setting data to be next allocated to each circuit based on the equipment data 14 and the profile transition data 17. Then, the equipment setting and control section 111 determines a new parameter setting data for the calculated profile by using the profile data 16, and sets the new parameter setting data to each of the equipments 121 and 122 through the equipment interfaces 110a and 110b. The data registering section 112 is a user interface to input to the system, various data necessary to operate the system such as the circuit status determination data 15, the profile data 16, and the profile transition data 17. For example, when the data is inputted to the system through the management network 200, a Web-based user interface corresponding to the access from the www browser is applied. Also, if the data is directly inputted to the automatic network provisioning server 11, the user interface with an input device such as a keyboard is applied.

It should be noted that the difference between the types of equipments can be absorbed by using equipment interfaces 100 (110a, 110b, . . . ) adaptive to the respective equipment types. Specifically, the system program section 13 has the plurality of equipment interfaces 110, and the equipment interface 110a collects the data of equipment 121, and the equipment interface 110b collects the data of equipment 122.

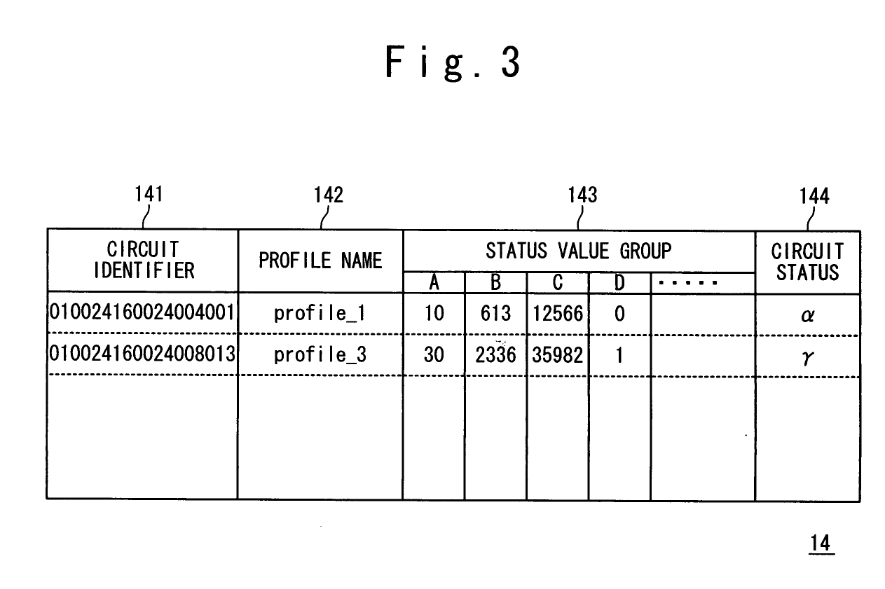

FIG. 3 shows an example of the data configuration of the equipment data 14. The equipment data 14 is composed of a circuit identifier 141, a profile name 142, a status value group 143 and a circuit status 144. The circuit identifier 141 is an identifier to uniquely identify the communication circuit allocated to each equipment. The profile name 142 shows a name showing a current parameter value group of each communication circuit. The status value group 143 is a group of various parameter values showing the operation status of each communication circuit. The circuit status 144 shows a determination result of a status of the communication circuit allocated to each equipment and is determined based on the parameter values of the status value group 143. In the equipment data 14, only the item of the circuit status 144 is different in character from the other items. The circuit status 144 is a field of not the a value actually collected from the equipment 121 or 122 but the result of a circuit status determination carried out by using circuit status determination data 15 based on the collected status value group 143.

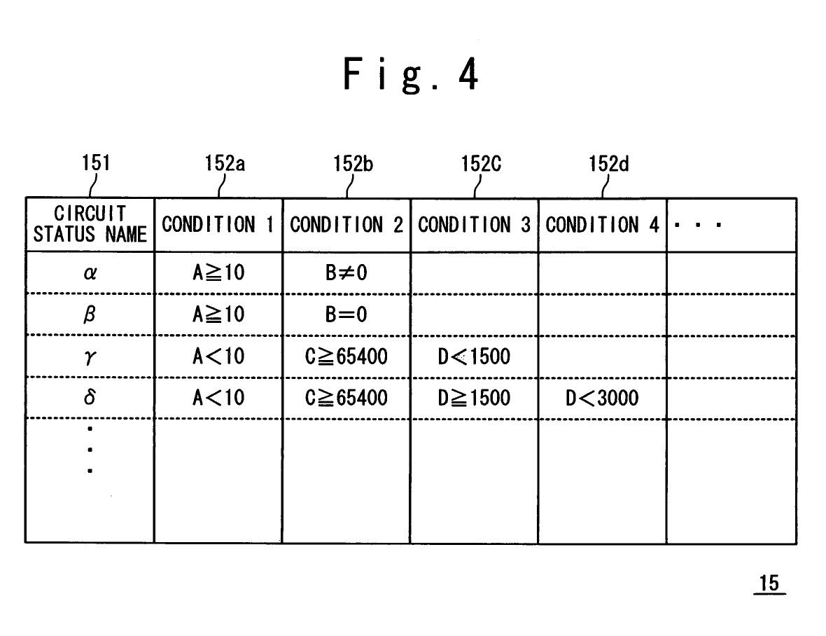

FIG. 4 shows an example of the data configuration of circuit status determination data 15. The circuit status determination data 15 is composed of a circuit status name 151 and definitions 152 as parameter values. Here, the number of conditions in the definition 152 is optional and the definition contains at least one of condition (152a, 152b, 152c, 152d, . . . ) for every circuit status. The circuit status name 151 is a name showing the status of each communication circuit allocated to each equipment. The status of the communication circuit is defined based on a combination of the conditions. More specifically, the status of the communication circuit is defined based on a logical operation (AND) of the respective condition specifications. In FIG. 4, it is defined in the following way,
α: (A≧10) and (B≠0)
β: (A≧10) and (B=0)
γ: (A<10) and (C≧65400) and (D<1500)
δ: (A<10) and (C≧65400) and (D≧1500) and (D<300)
   It should be noted that the parameters A, B, C, and D used in the conditions are the same as the parameters A, B, C, D, . . . in the equipment data 14 shown in FIG. 3. The circuit status of the communication circuit which satisfies the combination of the above-mentioned conditiions is determined as α, β, γ, and δ in the circuit status name 151.

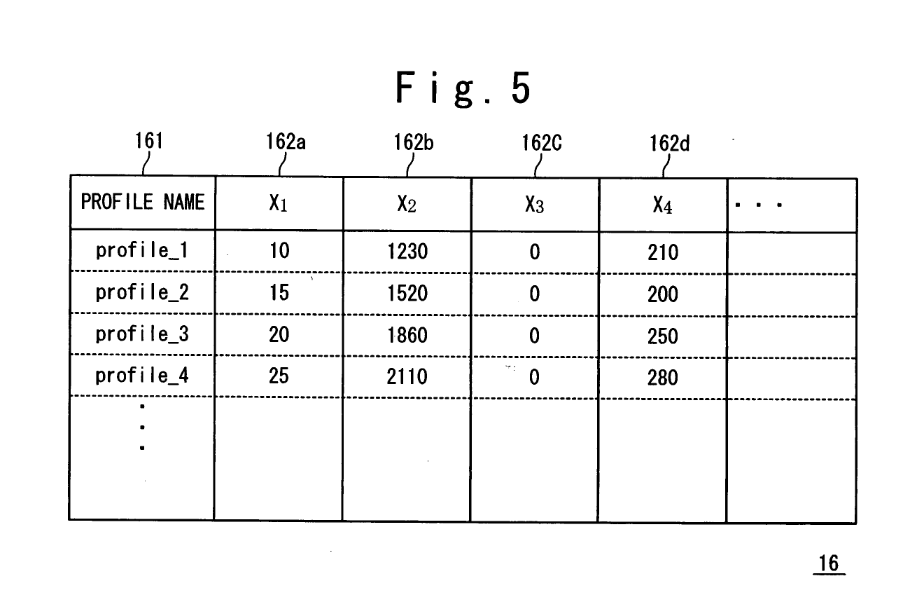

FIG. 5 shows an example of the data configuration of the profile data 16. The profile data 16 is composed of a profile name 161 and a group of parameter values (X1 162a, X2 162b, X3 162c, X4 162d, . . . ). The profile name 161 shows a name of the profile. The profile is specified based on a combination of parameter values. In the profile data 16 shown in FIG. 5, the definition of each profile is as follows.

Profile_1 is defined as a combination of the values, X1=10, X2=1230, X3=0, and X4=210.

Profile_2 is defined as a combination of the values, X1=15, X2=1520, X3=0, and X4=200.

Profile_3 is defined as a combination of the values, X1=20, X2=1860, X3=0, and X4=250.

Profile_4 is defined as a combination of the values, X1=25, X2=2110, X3=0, and X4=200.

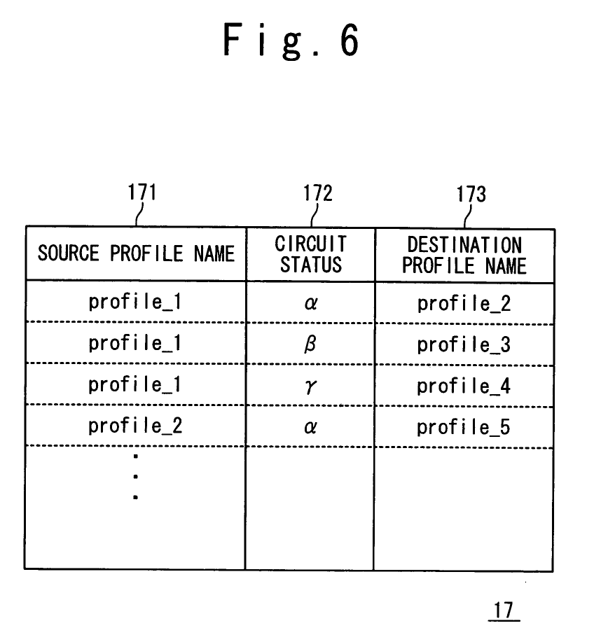

FIG. 6 shows an example of the data configuration of the profile transition data 17. The profile transition data 17 is composed of a source profile name 171, a circuit status 172, and a destination profile name 173. The source profile name 171 shows the name of the profile before a transition or change. The circuit status 172 shows a transition condition which is equivalent to the determination result of the communication circuit status. The destination profile name 173 shows a profile as the destination of the transition when the condition is met. The profile transition data 17 shown in FIG. 6 is interpreted as follows.

The profile Profile_2 is allocated to the communication circuit that the profile name is Profile_1 and the circuit status is α.

The profile Profilex_3 is allocated to the communication circuit that the profile name is Profile_1 and the circuit status is β.

The profile Profile_4 is allocated to the communication circuit that the profile name is Profile_1 and the circuit status is γ.

The profile Profile_5 is allocated to the communication circuit that the profile name is Profile_2 and the circuit condition is α.

It should be noted that the circuit status 172 is either of the values (α, β, γ, δ, . . . ) defined as the circuit status name 151 in the circuit status determination data 15 shown in FIG. 4. Also, the source profile name 171 and the destination profile name 173 are either of the values (Profile_1, Profile_{—}2, Profile_{—}3, Profile_{—}4, . . . ) defined as the profile name 161 in the profile data 16 shown in FIG. 5.

Next, the operation of the automatic network provisioning system will be described. The circuit status determination data 15, the profile data 16, and the profile transition data 17 are registered by the data registering section 112 on the automatic network provisioning server 11, prior to an ordinary operation. The data registering section 112 is realized by a general loading method such as the registration of access from a WWW browser and the registration of command input on the server.

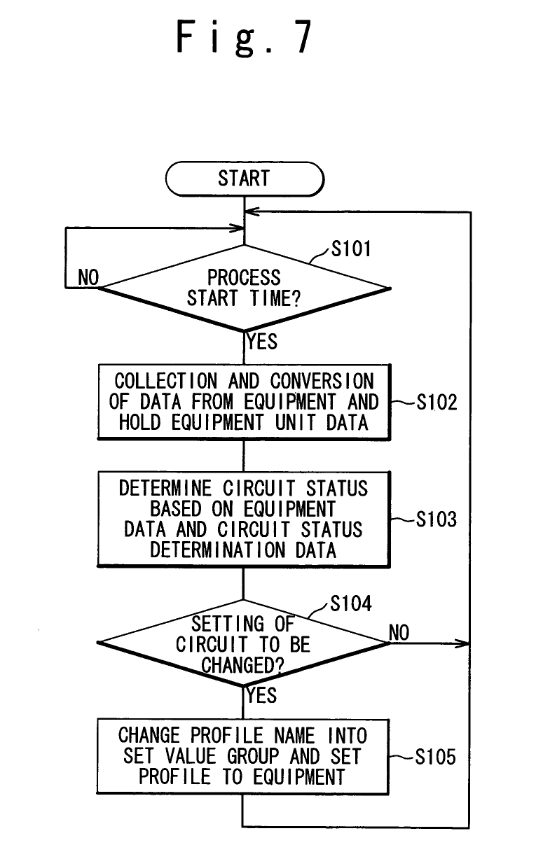

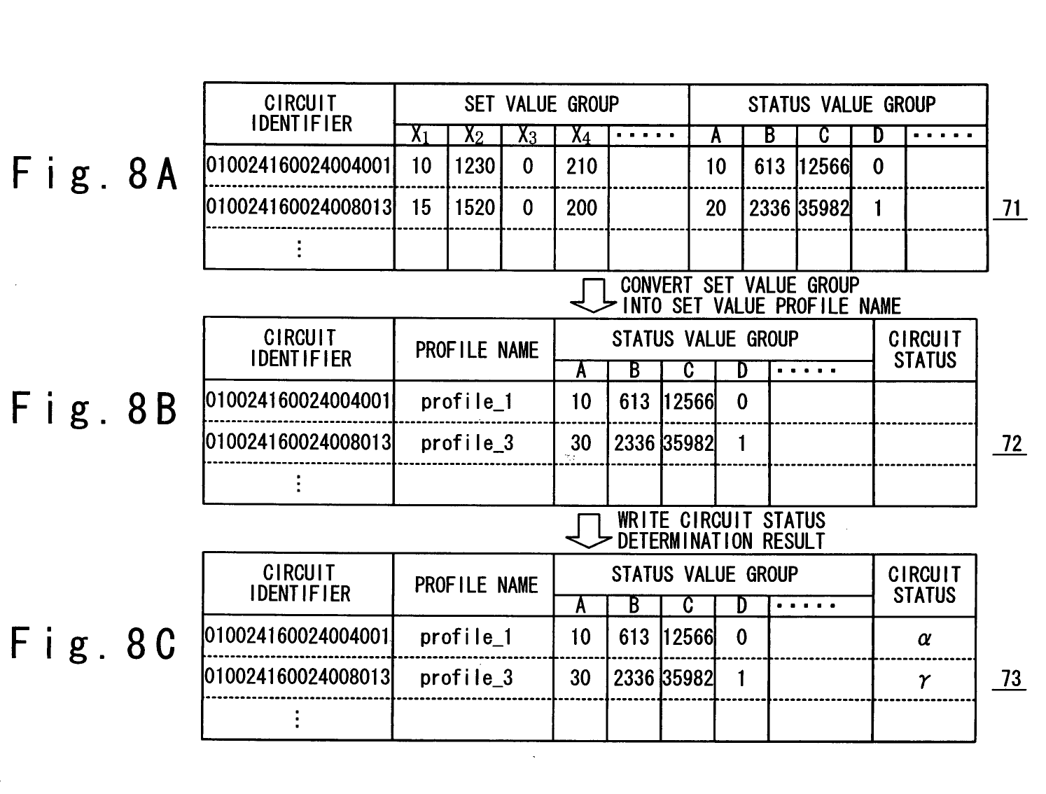

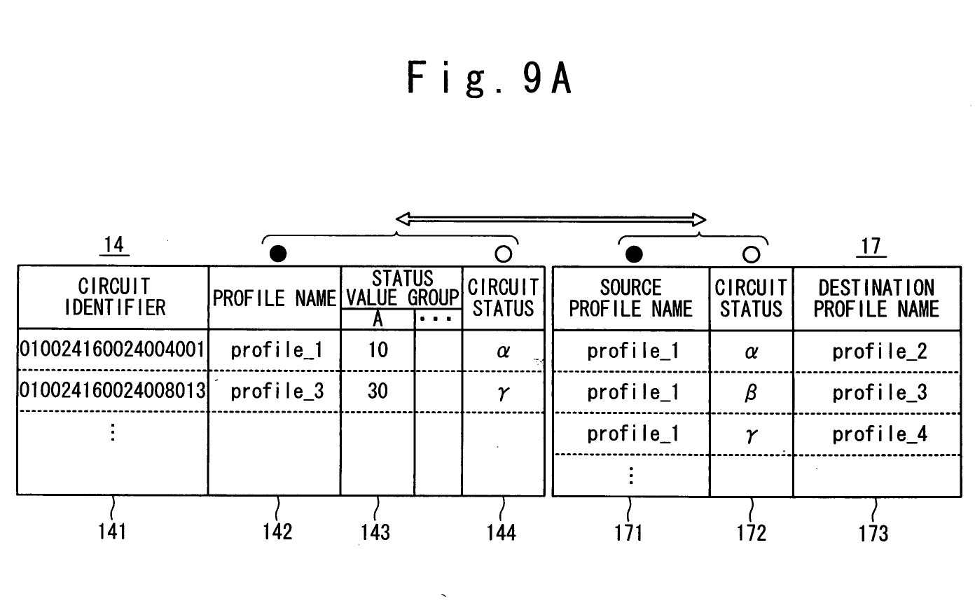

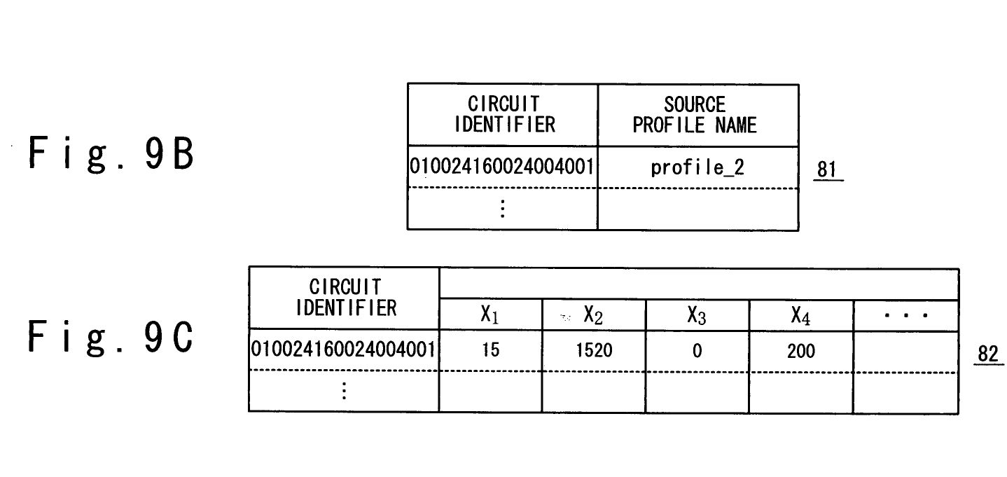

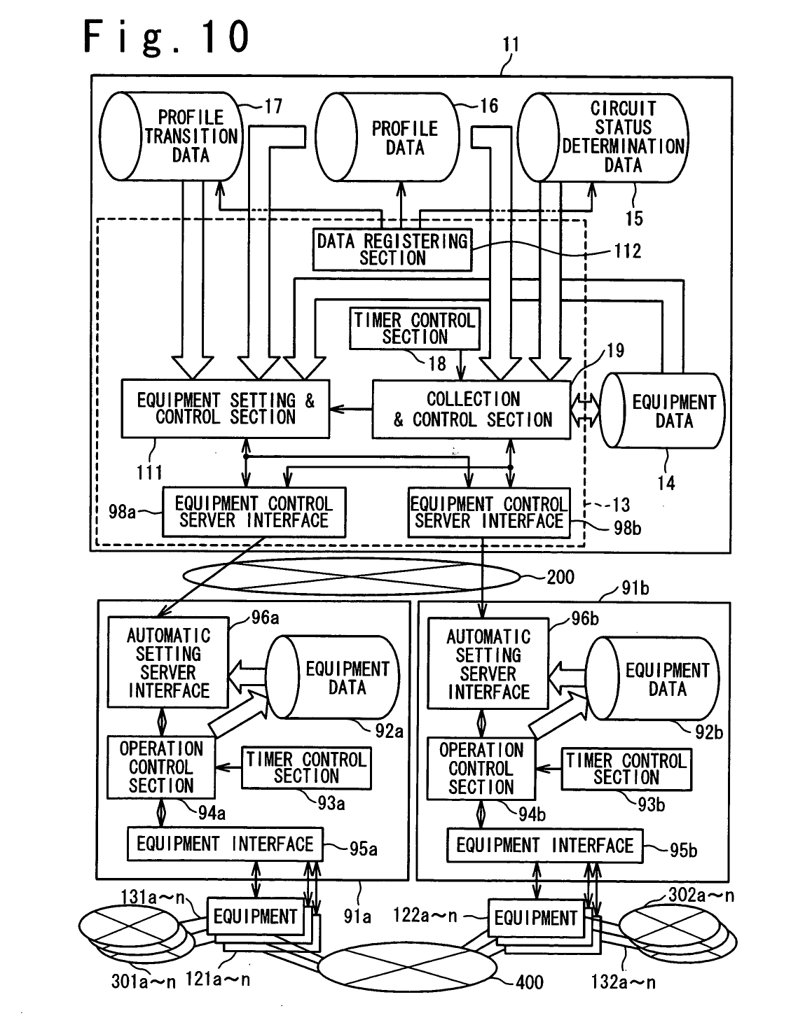

FIG. 7 shows a flow of the ordinary operation of the automatic network provisioning server 11. Also, FIGS. 8A to 8C show the change of the equipment data in the ordinary operation of the automatic network provisioning server. Also, FIGS. 9A to 9C show a method of the generation of circuit setting data in the ordinary operation of the automatic network provisioning server 11. With reference to these figures, the operation of the automatic network provisioning system will be described.

When the operation of the system is started, the automatic network provisioning server 11 determines whether or not the timer control section 18 is at a process start time which is previously and optionally set through the data registering section 112 (Step S101). In case of the process start time (Step S101/Yes), the timer control section 18 notifies the start of the process to the collection and control section 19. When the start of the process is notified from the timer control section 18, the collection and control section 19 generates an acquisition instruction and transmits it to the equipments 121 and 122. Thus, current parameter setting data and parameter status data 71 held by the equipments 121 and 122 are collected through the equipment interfaces 110a and 110b. These data are shown as a combination of the circuit identifier, the set value group (parameter value group of parameter setting data) and the status value group (actual parameter value group of parameter status data), as shown in FIG. 8A.

The collection and control section 19 compares the profile data 16 and the collected parameter value group to search the profile name 161. Then, the collection and control section 19 converts the collected parameter value group into a corresponding profile name whose parameter value group coincides with the collected parameter value group in the profile data 16. For example, it is supposed that the collected parameter value group is a following group, X1=10, X2=1230, X3=0, X4=210, . . . In this case, the parameter value group is coincident with Profile_1 in the profile data 16 shown in FIG. 5. Therefore, the collection and control section 19 converts this collected parameter value group into the profile Profile_{—}1. The collection and control section 19 holds data 72 generated in this way as the equipment data 14 (Step S102). It should be noted that at this step, the field of the circuit status of the equipment data 14 becomes empty.

Next, the collection and control section 19 reads out the circuit status determination data 15, and selects one of the communication circuits corresponding to the conditions of each circuit status from the equipment data 14 in accordance with the definition of the circuit status. Then, the collection and control section 19 writes a circuit status name for the conditions in the circuit status field for the selected communication circuit of the equipment data 14 (Step S103). For example, the status value group, A=10, B=613, C=12566, D=0, . . . corresponds to the circuit status a in the circuit status determination data 15 shown in FIG. 4. Therefore, the collection and control section 19 writes “α” in the circuit status field for the profile Profile_1 of the equipment data, as shown in FIG. 8C. In this way, the data 73 in which the circuit status is written is held in the automatic network provisioning server 11 as the equipment data 14.

Next, the collection and control section 19 issues an instruction to the equipment setting and control section 111 to carry out the setting. When receiving this instruction, the equipment setting and control section 111 carries out determination of whether the combination of the profile name 142 and the circuit status 144 in the equipment data 14 is coincident with the combination of the source profile name 171 and the circuit status 173 in the profile transition data 17. In the other words, the fields with black circles shown in FIG. 9A are compared and the fields with white circles shown in FIG. 9A are compared and a combination of coincident fields is searched. Thus, the communication circuit of a setting change object is searched (Step S104). As a result, the data 81 is obtained to show the setting change object circuit and the profile name to be set next, as shown in FIG. 9B. For example, it is supposed that in the equipment data 14, the profile name 142 of the communication circuit is “Profile_1” and the circuit status 144 thereof is “α”. In this case, the profile transition data 17 is searched for a combination of the transition origin profile name 171 of “Profile_1” and the circuit status 173 of “α”. Thus, the profile name to be set next is determined as “Profile_2.

It should be noted that when no communication circuit having a combination of a source profile name and a circuit status coincident with the combination of the profile name 142 and the circuit status 144 is found in the step S104, it is regarded that the setting change object does not exist and the process is ended.

Moreover, the equipment setting and control section 111 determines a new parameter value group (X1 162a, X2 162b, X3 162c, X4 162d, . . . ) to be allocated to the setting change object circuit based on the data 81 by using the profile data 16. For example, the parameter set corresponding to Profile_2 is X1=15, X2=1520, X3=0, X4=200, . . . in the profile data 16 shown in FIG. 5. Therefore, the equipment setting and control section 111 acquires a new parameter data as the parameter value group of the communication circuit for the destination profile name of Profile_2 and generates the data 82 for the new parameter data, as shown in FIG. 9C. The equipment setting and control section 111 carries out the setting through the equipment interfaces 110a and 110b to the respective equipments 121 and 122 by using the data 82 for the setting (Step S105).

In this way, according to the automatic network provisioning system in this embodiment, the following effects are achieved.

(1) The circuit status determination of the communication circuit for each equipment to connect a terminal on the data network 301 or 302 with the computer network 400 is carried out based on the equipment data collected through the management network 200 from each equipment. An appropriate profile is allocated to the communication circuit and a set value group is determined. Thus, it is possible to dynamically carry out an automatic setting in accordance with the operation situation of each communication circuit.

(2) The configuration of logical data (set value group) used in the circuit status determination and the allocation of the profile is flexible and the change is easy. Therefore, the operation of the system can be changed only by replacing the logical data by the data registering section, even in case that a new operation know-how is applied to the system and that new technique is introduced on the side of the circuit so that the setting and parameter set is changed.

(3) The selection of the profile to be set is carried out based on the operation status of the communication circuit. Therefore, the logical data never increases and becomes complicated in the circuit status determination data and the profile transition data, even if the number of the equipments to be controlled increases.

(4) The collection and the control section which carries out the circuit status determination and the equipment setting and control section which calculates transition of the profile are independent from the equipment interfaces. Therefore, it is sufficient to add a new equipment interface to the system program even when a different type of equipment (equipment of another vender) is added.

It should be noted that the collection of the equipment data is carried out at the process start time in the first embodiment. However, the collection may be started in response to an instruction supplied through the data registering section.

[Second Embodiment]

The configuration in the automatic network provisioning server according to the first embodiment of the present invention is not limited to the configuration implemented in a single apparatus. For example, when a new equipment to be controlled is added, it would be sometimes desirable that a new equipment interface for the equipment is configured as a system separated from the automatic network provisioning server. The automatic network provisioning system according to the second embodiment of the present invention will be described as an example that the equipment interface is configured as an independent configuration.

FIG. 10 shows the configuration of the automatic network provisioning system according to the second embodiment. In this system, the automatic network provisioning server 11, and equipment control servers 91a and 91b are connected through a management network 200. The equipment control servers 91a and 91b except for the storage units may be realized in software. Equipments 121a to 121n, and 122a to 122n are connected with the equipment control servers 91a and 91b, respectively. The equipments 121a to 121n connect the data networks 301a to 301n with the computer network 400 such as the Internet through communication circuits 131a to 131n. The equipment 122a to 122n connect the data networks 302a to 302n with the computer network 400 such as the Internet through communication circuits 132a to 132n, respectively. The automatic network provisioning server 11 is substantially the same as that of the first embodiment but has equipment control server interfaces 98a and 98b in place of the equipment interfaces 110a and 10b. The equipment control server interfaces 98a and 98b are same in configuration and function as interfaces with equipment control servers.

The equipment control server 91a is composed of a storage unit of an equipment data 92a, a timer control section 93a, an operation control section 94a, an equipment interface 95a and an automatic setting server interface 96a. The equipment interface 95a is similar to equipment interface 110a in the first embodiment and interfaces the equipments 121a to 121n. The timer control section 93a generates a trigger at a predetermined time for the equipment data collection from each of the equipments 121a to 121n under management. The operation control section 94a generates an instruction in response to the trigger and transmits it to one of the equipments 121a to 121n through the equipment interface 95a. Thus, the equipment data 92a is collected through the equipment interface 95a and is stored in the storage unit. The collection may be carried out to all the equipments 121a to 121n or a corresponding one of the equipments 121a to 121n in response to the instruction.

The timer control section 18 generates a trigger at a predetermined time for the equipment data collection from the equipments 121a to 121n. The collection and control section 19 generates a transfer instruction and transmits it through the equipment control server interface 98a to the automatic setting server interface 96a.

The automatic setting server interface 96a receives the transfer instruction from the automatic network provisioning server 11, reads out the equipment data 92a from the storage unit and delivers the equipment data 92a to the automatic network provisioning server 11. Thus, like the first embodiment, the status determination is carried out and a new parameter data is determined.

The setting of the equipments 121a to 121n, and 122a to 122n is carried out in accordance with the following procedure. The automatic setting server interface 96a in the equipment control server 91a receives the new parameter data sent from the automatic network provisioning server 11 through the equipment control server interface 98a, and delivers the new parameter data to the operation control section 94a. The operation control section 94a carries out the setting to a corresponding one of the communication circuits 131a to 131n through the equipment interface 95a so that a terminal on a corresponding one of the data networks 301a to 301n can transmit and receive data onto and from the Internet 400 through the corresponding one of the communication circuits 131a to 131n and the corresponding one of the equipment 121a to 121n.

It should be noted that the equipment control server 91b has the same configuration as the equipment control server 91a, and carries out the same operation as described above.

In this embodiment, a part of the function module installed in the single automatic network provisioning server 11 in the first embodiment is installed in the equipment control server 91a or 91b. Thus, a distributed server configuration can be realized. By adopting such a configuration, when a new type of equipment is added under the management of the system, it is sufficient to add an equipment control server in accordance with the equipment. Therefore, the change of the configuration of the automatic network provisioning server 11 is not necessitated. Thus, the management of the system becomes easy.

[Third Embodiment]

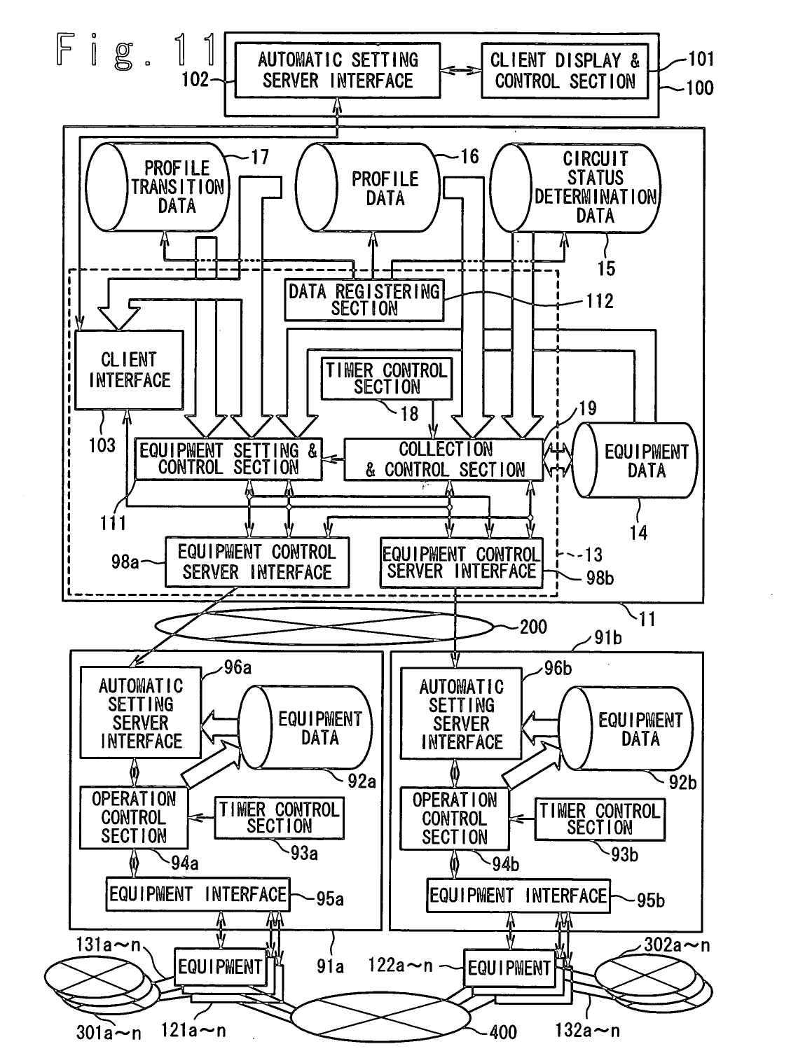

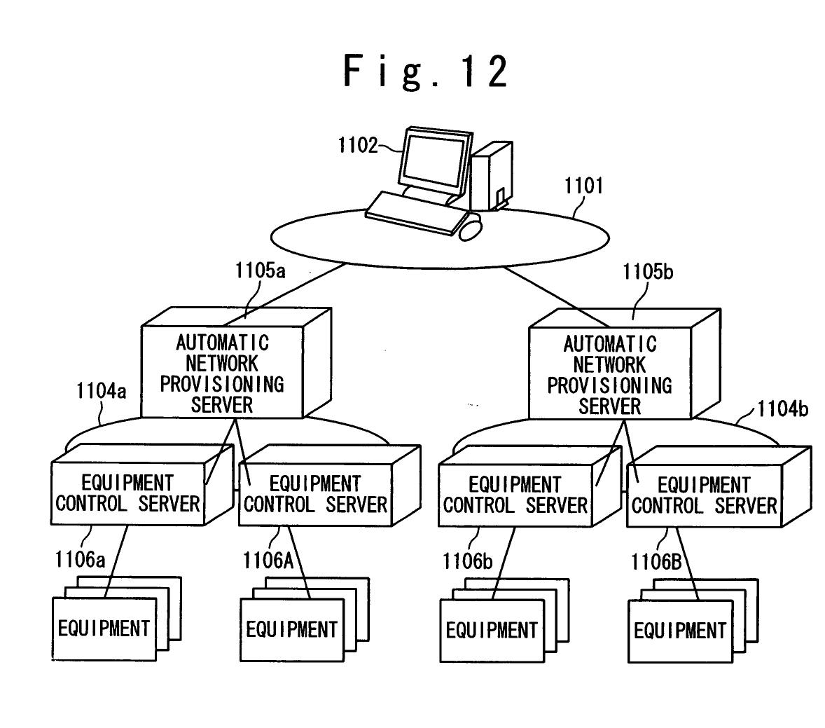

FIG. 11 shows the configuration of the automatic network provisioning system according to the third embodiment of the present invention. The automatic network provisioning system in the third embodiment is almost the same as the automatic network provisioning system in the second embodiment. The third embodiment is different from the second embodiment in that an operator client 100 and client interface 103 are further provided. The operator client 100 has a client display and control section 101 and an automatic setting server interface 102. The client display and control section 101 controls the display and the setting of a client screen. The automatic setting server interface 102 and the client interface 103 are interfaces to send and receive data between the automatic setting server 11 and the operator client 100. In this embodiment, the operator client 100 generates a trigger and transmits it to the collection and control section 19 through the client interface 103. As a result, the above-mentioned operation is started. Also, the operator client 100 can receives the equipment data from the equipment control server through the equipment control server interface, and the profile data, the equipment data after the status determination and the new parameter data from the equipment setting and control section through the client interface 103. Thus, the equipment data of the communication circuit allocated to an optional equipment is displayed on the client display and control section 101 through the client interface 103 and the equipment data is compared with the profile data when the parameter values are to be changed.

In the automatic network provisioning system according to this embodiment, it is possible to use both of the automatic setting of the network and a manual setting by an operator of the operator client 100. For example, it is supposed that the timer control section 18 of the automatic network provisioning server 11 is set to generate a trigger only at a predetermined time in night, and a call center process by the operator is carried out at in a time zone of daytime. In this case, the automatic setting by the automatic network provisioning server 11 and the manual setting by the operator can be used without competing.

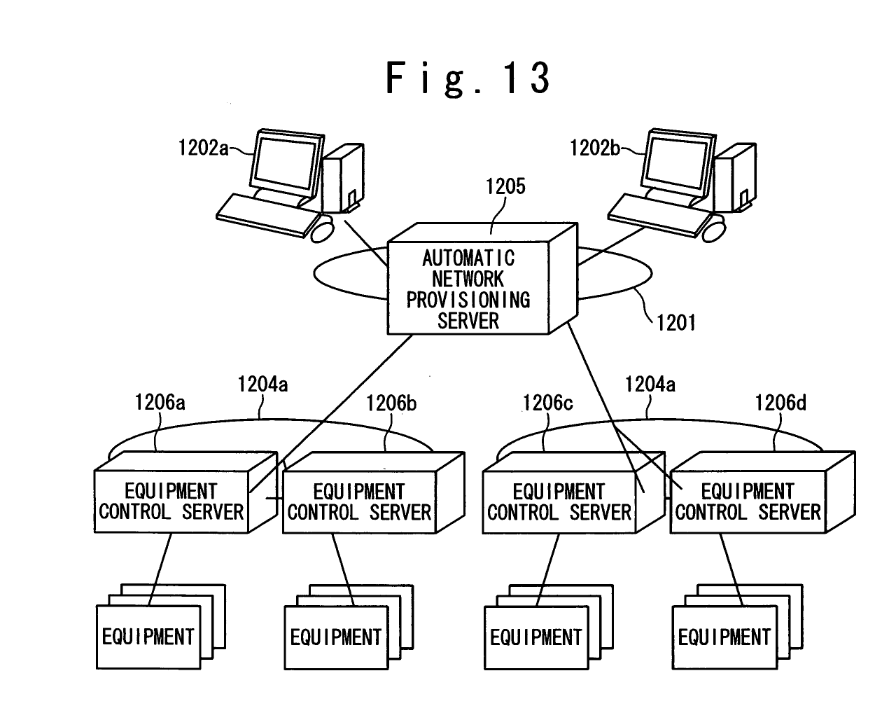

Next, a configuration example of the system will be described. When this system is installed actually, a distributed system as shown in FIG. 12 and a center management system as shown in FIG. 13 are used.

In the distributed system, an operator client 1102 is arranged in a customer support center 1101, and the automatic network provisioning servers 1105 (1105a, 1105b) and the equipment control servers 1106 (1106a, 1106A, 1106b, 1106B, . . . ) are arranged in area bases 1104a, 1104b, . . . to manages the equipments under the equipment control servers 1106. In the distributed system, different theories can be set to the automatic network provisioning servers 1105a and 1105b in the respective area bases. Therefore, the operation is possible according to area characteristics, e.g., in case of ADSL, optimal configurations are different on the network operation due to a track length difference between a city section where a station and an end user are close and a local area where the stations are less. Also, the automatic network provisioning servers and the equipment control servers can be connected by a LAN. Therefore, an exclusive communication circuit is unnecessary. Moreover, it is possible to distribute the load of the automatic network provisioning server.

On the other hand, in the center management system, the operator client 1202 and the automatic network provisioning server 1205 are arranged in a customer support center 1201, and equipment control servers 1206a, 1206b, . . . are arranged in the respective area bases 1204a, 1204b, . . . to manage the equipments under the equipment control servers 1206a, 1206b, . . . . In the center management system, because the automatic network provisioning server 1205 is arranged in the customer support center, the management and maintenance of the system are easy. Also, because the operator client and the automatic network provisioning server 11 can be connected by a LAN, an exclusive use communication circuit is unnecessary.

As described above, in the automatic network provisioning system of the present invention, an appropriate parameter value group can be dynamically selected and set to an equipment which connects a terminal on an data networks with a computer network, in accordance with an operation situation of the equipment. The collection and control section 19 carries out the determination of the circuit status (the reliability and a bit rate of the communication when the terminal on the data network 300 carries out the communication through the communication circuit 131 or 132 and the equipment 121 or 122) to the equipment data 14 collected from the equipment (node) 121 or 122 through the equipment interface 110a or 110b in accordance with various logical characteristic data (circuit status determination data 15, profile 16, and profile transition data 17). Thus, the collection and control section 19 determines the set value group to be set next by the equipment setting and control section 111 based on the determination result. Thus, the dynamic setting is realized in accordance with the operation situation of the communication circuit 131 or 132 allocated to the equipment 121 or 122 through the equipment interface 110a or 110b.

Also, the logical data are manipulated in the data format of table, and the configuration is flexible. As a result, it is possible to easily carry out replacement of the logical data by the data registering section 112. Therefore, it is possible for the present invention to easily measure to a case that the operation change of the system is requested as the operation know-how is accumulated and the parameter of the setting of the equipment and the status are added with introduction of new circuit technique. Moreover, the setting to the equipment 121 or 122 is not determined based on physical elements such as the addresses of the equipments 121 or 122 but is determined based on the circuit status calculated using the circuit status determination data 15 to the equipment data 14. Even if the number of the equipments (the number of the circuits) under the system management increases, the logical data (the circuit status determination data 15, the profile data 16, the profile transition data 17) never increase and become complicated.

It should be noted that the above embodiments is suitable examples of the present invention but the present invention is never limited to these. For example, in the above embodiments, cases that two kinds of equipments exist under management by the automatic network provisioning server and the equipment control server is described. However, more types of equipments can be provided under the management. In this way, the present invention can be variously modified.

In the present invention, it is possible to dynamically carry out automatic setting in accordance with the request from the end user who uses the communication circuit and the operation situation peculiar to the communication circuit allocated to each node for the terminal on the data network to send and receive data. Also, it is possible to simply carry out an automatic setting without increase of the description of the setting to be applied to the communication circuit allocated to each node (logic description), even if the number of the nodes increases. Moreover, it is possible to easily change the description of the setting to be applied to the communication circuits allocated to each node (the logic description).

1. An automatic network provisioning system comprising:
an equipment configured to connect a terminal on a first network with a second network through a communication circuit based on a current parameter data; and
an automatic network provisioning section connected with said equipment and configured to acquire an equipment data containing an actual parameter data from said equipment in response to an acquisition instruction and to dynamically set a new parameter data to said equipment based on said actual parameter data.

2. The automatic network provisioning system according to claim 1, wherein said automatic network provisioning section comprises:
an automatic network provisioning server connected with said equipment through a management network and configured to acquire said equipment data containing said actual parameter data in response to said acquisition instruction and to dynamically set said new parameter data to said equipment based on said acquired actual parameter data.

3. The automatic network provisioning system according to claim 1, wherein said automatic network provisioning section comprises:
an equipment control server connected with said equipment and configured to acquire said equipment data containing said actual parameter data in response to said acquisition instruction, to transfer said equipment data in response to a transfer instruction, and to set said new parameter data to said equipment when said new parameter data is received; and
an automatic network provisioning server connected with said equipment through a management network, configured to issue said transfer instruction to said equipment control server, to determine said new parameter data based on said actual parameter data and to transfer said new parameter data to said equipment control server.

4. The automatic network provisioning system according to claim 3, further comprising:
a plurality of said equipment control servers provided for said automatic network provisioning server provided in an area where said automatic network provisioning server is provided; and
a plurality of said equipments provided for each of said equipment control servers.

5. The automatic network provisioning system according to claim 3, further comprising:
a plurality of said equipment control servers provided for said automatic network provisioning server in a first area, said automatic network provisioning server is provided in a second area different from said first area; and
a plurality of said equipments provided for each of said equipment control servers.

6. An automatic network provisioning server for controlling an equipment configured to connect a terminal on a first network with a second network through a communication circuit based on a current parameter data, comprising:
an interface;
a collection section which acquires a equipment data containing an actual parameter data from said equipment through said interface in response to an acquisition instruction, and determines a status of said communication circuit based on said actual parameter data; and
an equipment setting section which determines a new parameter data based on a result of the determination and sets said new parameter data to said equipment through said interface.

7. The automatic network provisioning server according to claim 6, further comprising:
a storage section which stores a conversion table;
wherein said collection section stores said equipment data in said storage section, reads out said equipment data from said storage section, and determines the status of said communication circuit based on said actual parameter data of said equipment data, and
said equipment setting section determines said new parameter data based on the determination result and said conversion table and sets said new parameter data to said equipment.

8. The automatic network provisioning server according to claim 6, further comprising:
a timer section which generates a trigger at a predetermined time,
wherein said collection section generates said acquisition instruction in response to said trigger.

9. The automatic network provisioning server according to claim 6, further comprising:
a client section which generates said acquisition instruction.

10. The automatic network provisioning server according to claim 6, wherein said interface depends on a type of said equipment.

11. An automatic network provisioning server for controlling an equipment configured to connect a terminal on a first network with a second network through a communication circuit based on a current parameter data, wherein an equipment control server is connected with said equipment and acquires equipment data containing an actual parameter data in response to an acquisition instruction, and sets said new parameter data to said equipment when said new parameter data is received, comprising:
a collection section which issues a transfer instruction to said equipment control server such that said equipment data containing said actual parameter data from said equipment is acquired, and determines a status of said communication circuit based on said actual parameter data; and
an equipment setting section which determines a new parameter data based on a result of the determination and transmits the new parameter data to said equipment control server such that said new parameter data is set to said equipment.

12. The automatic network provisioning server according to claim 11, further comprising:
a storage section which stores a conversion table,
wherein said collection section stores said equipment data in said storage section, reads out said equipment data from said storage section, and determines the status of said communication circuit based on said actual parameter data of said equipment data, and
said equipment setting section determines said new parameter data based on the determination result and said conversion table and transmits said new parameter data to said equipment control server.

13. The automatic network provisioning server according to claim 11, further comprising:
a timer section which generates a trigger at a predetermined time, and
said collection section generates said transfer instruction in response to said trigger.

14. The automatic network provisioning server according to claim 11, wherein said communication circuit is an ADSL circuit.

15. An equipment control server for controlling an equipment configured to connect a terminal on a first network with a second network through a communication circuit based on a current parameter data, comprising:
an interface;
a control section which issues an acquisition instruction to said equipment through said interface such that an equipment data containing said actual parameter data is acquired, transfers said equipment data in response to a transfer instruction, and sets a new parameter data to said equipment when said new parameter data which is determined based on said equipment data is received.

16. The equipment control server according to claim 15, further comprising:
a timer section which generates a trigger at a predetermined time, and
said control section generates said acquisition instruction in response to said trigger.

17. The equipment control server according to claim 15, wherein said communication circuit is an ADSL circuit.

18. The equipment control server according to claim 15, wherein said interface depends on a type of said equipment.

19. A method of dynamically changing a setting of an equipment to connect a terminal on a first network with a second network through a communication circuit based on a current parameter data, said method comprising:
acquiring an equipment data containing an actual parameter data from said equipment in response to an acquisition instruction; and
dynamically setting a new parameter data generated based on said actual parameter data to said equipment.

20. The method according to claim 19, wherein said acquiring and said dynamically setting are carried out in a single server.

21. The method according to claim 19, wherein said acquiring and said dynamically setting are carried out in a first server,
said method further comprises:
generating a transfer instruction in a second server;
transferring said equipment data from said first server to said second server in response to said transfer instruction;
determining said new parameter data based on said actual parameter data in said second server; and
transferring said new parameter data to said first server.

22. The method according to claim 21, wherein said determining comprises:
determining a status of said communication circuit based on said actual parameter data; and
determining said new parameter data based on the determination result.

23. The method according to claim 19, further comprising:
generating a trigger at a predetermined time in said server; and
generating said acquisition instruction in response to said trigger.

24. The method according to claim 21, further comprising:
generating a first trigger at a predetermined time; and
generating said acquisition instruction in response to said first trigger.

25. The method according to claim 24, further comprising:
generating a second trigger at a predetermined time; and
generating said transfer instruction in response to said second trigger.

26. The method according to claim 19, further comprising:
generating said acquisition instruction externally.

27. A computer-readable software product for realizing a method comprising:
acquiring an equipment data containing an actual parameter data from a equipment through an interface in response to an acquisition instruction, wherein said equipment connects a terminal on a first network with a second network through a communication circuit based on a current parameter data;
determining a status of said communication circuit based on said actual parameter data;
determining a new parameter data based on a result of the determination; and
setting said new parameter data to said equipment through said interface.

28. The software product according to claim 27, wherein said determining a new parameter data comprises:
determining said new parameter data based on the determination result and said conversion table.

29. The software product according to claim 27, wherein said method further comprising:
generating a trigger at a predetermined time; and
generating said acquisition instruction in response to said trigger.

30. The software product according to claim 27, wherein said method further comprises:
generating said acquisition instruction from a client section.

31. The software product according to claim 27 wherein said interface depends on a type of said equipment.

32. A computer-readable software product for realizing a method of controlling an equipment configured to connect a terminal on a first network with a second network through a communication circuit based on a current parameter data, wherein said method comprising:
issuing a transfer instruction to an equipment control server such that an equipment data containing an actual parameter data from said equipment is acquired;
determining a status of said communication circuit based on said actual parameter data;
determining a new parameter data based on a result of the determination; and
transmitting the new parameter data to said equipment control server such that said new parameter data is set to said equipment.

33. The software product according to claim 32, wherein said determines a new parameter data comprises:
determining said new parameter data based on the determination result and a conversion table.

34. The software product according to claim 32, wherein said method further comprises:
generating a trigger at a predetermined time; and
generating said transfer instruction in response to said trigger.

35. A computer-readable software product for realizing a method of controlling an equipment configured to connect a terminal on a first network with a second network through a communication circuit base on a current parameter data, wherein said method comprising:
issuing an acquisition instruction to said equipment through an interface such that an equipment data containing said actual parameter data is acquired;
transferring said equipment data in response to a transfer instruction; and
setting a new parameter data to said equipment when said new parameter data which is determined based on said equipment data is received.

36. The software product according to claim 35, wherein said method further comprises:
generating a trigger at a predetermined time; and
generating said acquisition instruction in response to said trigger.

37. The software product according to claim 35, wherein said interface depends on a type of said equipment.
